(19) United States
(12) Patent Application Publication
(10) Pub. No.: US 2013/0135256 A1
(43) Pub. Date: May 30, 2013

(54) ORGANIC LIGHT EMITTING DIODE DISPLAY

(71) Applicants: Won-Ki HONG, Suwon-si (KR); Seung Ho NAM, Seongnam-si (KR); Soo Guy RHO, Suwon-si (KR); Ji Hong PARK, Suwon-si (KR)

(72) Inventors: Won-Ki HONG, Suwon-si (KR); Seung Ho NAM, Seongnam-si (KR); Soo Guy RHO, Suwon-si (KR); Ji Hong PARK, Suwon-si (KR)

(21) Appl. No.: 13/434,604

(22) Filed: Mar. 29, 2012

(30) Foreign Application Priority Data
Nov. 24, 2011 (KR) 10-2011-0123574

(51) Int. Cl. G09G 3/30; G06F 3/042

(52) U.S. Cl. 345/175; 345/76

(57) ABSTRACT

Provided is an organic light emitting diode display. An organic light emitting diode display includes: a touch panel that includes a first substrate, a first electrode disposed on the first substrate, a photosensor disposed on the first electrode, and a second electrode disposed on the photosensor; and a display panel that includes a second substrate, a thin film transistor disposed on the second substrate, a pixel electrode disposed on the thin film transistor, an emission layer disposed on the pixel electrode, a common electrode disposed on the emission layer, a passivation layer disposed on the common electrode, and a column spacer disposed on the passivation layer, wherein the display panel is disposed on the touch panel, and the column spacer and the second electrode face each other and are spaced apart from each other.

### CROSS-REFERENCE TO RELATED APPLICATION

This application claims priority to and the benefit of Korean Patent Application No. 10-2011-0123574 filed in the Korean Intellectual Property Office on Nov. 24, 2011, the entire contents of which are incorporated herein by reference.

### BACKGROUND OF THE INVENTION

(a) Field of the Invention

The present invention relates to an organic light emitting diode display.

(b) Description of the Related Art

Recently, portable thin film flat panel displays have become widely used. Among the various types of flat panel displays, electroluminescence display devices are a self-emission type display device. Because electroluminescence display devices have a wide viewing angle, excellent contrast, and a rapid response speed, they are being watched as a next generation of display device. Further, an organic light emitting diode display that uses an organic material as for the emission layer has excellent luminance, driving voltage and response speed characteristics as compared to an inorganic light emitting diode display, and can also implement polychrome.

Technologies for applying a touch panel function to organic light emitting diode displays have been studied. If the touch panel function is applied, an input device function may be obtained by contacting a user's finger or pen with a panel surface of the organic light emitting diode display.

In one method thereof, a photosensor, and a touch sensor that includes a transparent electrode wire for reading a change in current by light of the photosensor are formed on the touch panel. In this case, to prevent light emitted by the emission portion from deteriorating the transmittance of the photosensor, the photosensor and transparent electrode wire are disposed only in a region that does not corresponding to the emission portion, that is, only in a non-emission region. Accordingly, the size of the area that the photosensor and transparent electrode wire can occupy is limited, which creates a problem in that sensing sensitivity and response speed are deteriorated.

The above information disclosed in this Background section is only for enhancement of understanding of the background and therefore it may contain information that does not form the prior art that is already known to a person of ordinary skill in the art.

### SUMMARY OF THE INVENTION

An organic light emitting diode display that includes a touch panel capable of enlarging a transparent electrode area transmitting a sensor area and a sensor signal by disposing a touch sensor at a lower portion of a display panel which includes an emission portion is provided.

An embodiment of the present invention provides an organic light emitting diode display including a touch panel that includes a first substrate, a first electrode disposed on the first substrate, a photosensor disposed on the first electrode, and a second electrode disposed on the photosensor; and a display panel that includes a second substrate, a thin film transistor disposed on the second substrate, a pixel electrode disposed on the thin film transistor, an emission layer disposed on the pixel electrode, a common electrode disposed on the emission layer, a passivation layer disposed on the common electrode, and a column spacer disposed on the passivation layer, wherein the display panel is disposed on the touch panel, and the column spacer and the second electrode face each other and are spaced apart from each other.

The pixel electrode may be a cathode, and the common electrode may be an anode.

Light generated in the emission layer may progress in a direction away from the first substrate toward the second substrate.

The second substrate may include an upper surface and a lower surface, and the thin film transistor may be disposed on the lower surface of the second substrate. The column spacer and the second electrode may be contacted when the upper surface of the second substrate is touched, such that capacitance formed between the first electrode and the second electrode may be changed.

The first electrode and the second electrode may be arranged in a matrix form, and the photosensor may be disposed at a portion where the first electrode and the second electrode cross.

The column spacer may be formed of a conductive material.

The column spacer may be disposed in a position to correspond to the position of the photosensor.

The pixel electrode and the common electrode may be formed of a transparent conductive material.

The sensing according to a change in the capacitance formed between the first electrode and the second electrode occurs simultaneously with a photosensing produced by the photosensor.

The photosensor recognizes a touch in response to at least one of covering or receiving light having a predetermined wavelength band.

In another aspect, an organic light emitting diode display includes a touch panel that includes a first substrate, a first electrode disposed on the first substrate, a photosensor disposed on the first electrode, and a second electrode disposed on the photosensor; a display panel that includes a second substrate including an upper surface and a lower surface, a plurality of gate lines disposed on the lower surface of the second substrate, a plurality of data lines crossing the plurality of gate lines, a first passivation layer covering the plurality of data lines, a pixel electrode disposed on the first passivation layer, an emission layer disposed on the pixel electrode, a common electrode disposed on the emission layer, and a second passivation layer disposed on the common electrode; and a plurality of sensing lines disposed on the upper surface of the second substrate, wherein the display panel is disposed on the touch panel.

The plurality of sensing lines cross the gate line, capacitance may be formed between the sensing line and the gate line, and if the upper surface of the second substrate is touched, the capacitance may be changed.

The pixel electrode may be a cathode, and the common electrode may be an anode.

Light generated in the emission layer may progress in a direction away from the first substrate toward the second substrate.

The first electrode and the second electrode may be arranged in a matrix form, and the photosensor may be disposed at a portion where the first electrode and the second electrode cross.

The pixel electrode and the common electrode may be formed of a transparent conductive material.

In yet another aspect, an organic light emitting diode display includes a touch panel that includes a first substrate, a first electrode disposed on the first substrate, an insulating layer disposed on the first electrode, and a second electrode disposed on the insulating layer; and a display panel that includes a second substrate, a thin film transistor disposed on the second substrate, a pixel electrode disposed on the thin film transistor, an emission layer disposed on the pixel electrode, a common electrode disposed on the emission layer, a passivation layer disposed on the common electrode, and a column spacer disposed on the passivation layer, wherein the display panel is disposed on the touch panel, and the column spacer and the second electrode face each other and are spaced apart from each other.

The pixel electrode may be a cathode, and the common electrode may be an anode.

Light generated in the emission layer may progress in a direction away from the first substrate toward the second substrate.

The first electrode and the second electrode may be arranged in a matrix form, and the insulating layer may include an insulation pattern disposed at a portion where the first electrode and the second electrode cross.

It is possible to enlarge a transparent electrode area transmitting a sensor area and a sensor signal by disposing a touch sensor at a lower portion of a display panel which includes an emission portion, thereby improving sensing sensitivity and a response speed.

### BRIEF DESCRIPTION OF THE DRAWINGS

FIG. 1 is a cross-sectional view of an organic light emitting diode display according to an exemplary embodiment.

FIG. 2 is a top plan view illustrating a touch panel of the organic light emitting diode display according to the exemplary embodiment of FIG. 1.

FIG. 3 is a circuit diagram illustrating a pixel of the organic light emitting diode display according to the exemplary embodiment of FIG. 1.

FIG. 4 is an enlarged view illustrating portion A of a display panel of the organic light emitting diode display according to the exemplary embodiment of FIG. 1.

FIG. 5 is a schematic diagram illustrating an electric field shape in the case where there is no touch in the organic light emitting diode display according to the exemplary embodiment of FIG. 1.

FIG. 6 is a cross-sectional view illustrating the case where a touch occurs on one surface of the organic light emitting diode display according to the exemplary embodiment of FIG. 1.

FIG. 7 is a schematic diagram illustrating an electric field shape in the case where the touch occurs in the organic light emitting diode display according to the exemplary embodiment of FIG. 6.

FIG. 8 is a graph illustrating a voltage change as a function of time in the case where the touch occurs in the organic light emitting diode display according to the exemplary embodiment of FIG. 6.

FIG. 9 is a cross-sectional view of an organic light emitting diode display according to another exemplary embodiment.

FIG. 10 is a cross-sectional view of an organic light emitting diode display according to yet another exemplary embodiment.

### DETAILED DESCRIPTION OF THE EMBODIMENTS

Hereinafter, exemplary embodiments will be described in detail with reference to the accompanying drawings. As those skilled in the art would realize, the described embodiments may be modified in various different ways, all without departing from the spirit or scope of the present disclosure. On the contrary, exemplary embodiments introduced herein are provided so that those skilled in the art can sufficiently understand the disclosure.

In the drawings, the thickness of layers, films, panels, regions, etc., are exaggerated for clarity. It will be understood that when a layer is referred to as being “on” another layer or substrate, it can be directly on the other layer or substrate, or intervening layers may also be present. Like reference numerals designate like elements throughout the specification.

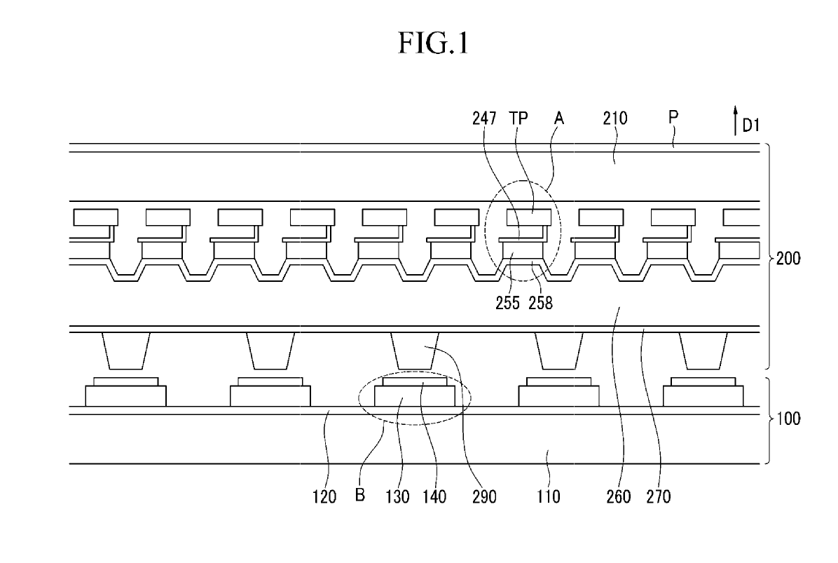

FIG. 1 is a cross-sectional view of an organic light emitting diode display according to an exemplary embodiment.

With reference to FIG. 1, in the organic light emitting diode display according to the exemplary embodiment, a display panel 200 is disposed on a touch panel 100. In the display panel 200, an emission layer 255 is formed, and light generated in the emission layer 255 progresses in a first direction D1 away from the touch panel 100 and up through the display panel 200.

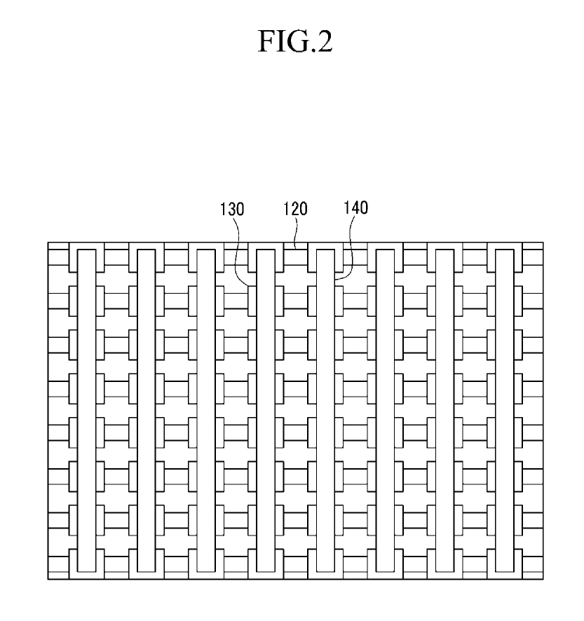

Hereinafter, with reference to FIG. 1 and FIG. 2, the touch panel 100 will be described in detail.

FIG. 2 is a top plan view illustrating a touch panel of the organic light emitting diode display according to the exemplary embodiment of FIG. 1.

With reference to FIG. 1 and FIG. 2, in the touch panel 100, a plurality of first electrodes 120 may be formed substantially in a horizontal direction in a stripe form on the first substrate 110. A plurality of photosensors 130 may be disposed on the first electrode 120, and a plurality of second electrodes 140 may be formed substantially in a vertical direction in a stripe form on the photosensor 130 and crossing the first electrode 120.

The first substrate 110 may be formed of, for example, a transparent glass material, but is not limited thereto, and may be formed for instance of a transparent plastic material. The second electrode 140 may be formed of, for example, a transparent conductive material so that external light may be transmitted therethrough. In an exemplary embodiment, the second electrode 140 may be made of an opaque conductive material, and in such a case, the width of the photosensor 130 in the horizontal direction may be larger than the width of second electrode 140, as shown in FIG. 2.

The photosensor 130 is disposed in a region where the first electrode 120 and the second electrode 140, which are arranged in a matrix form, cross over each other. Power may be applied to the photosensor 130 through the first electrode 120 and the second electrode 140.

The first electrode 120, the second electrode 140, and photosensor 130 act as a photosensor that senses external light. The touch panel 100 that includes the first electrode 120, the second electrode 140, and photosensor 130 senses the touch of a user by sensing a change in incident intensity of external light, which is changed by the touch when the user touches the touch panel. In detail, the photosensor 130 converts a light-received photon into a current, and is operated based on a photoelectric effect concept that is modified based on the intensity of incident light. A basic structure for such a photosensor is a PN conjunction structure. In operation, a negative voltage is applied to the P type semiconductor and a positive voltage is applied to the N type semiconductor. When light is incident on the photosensor, an electron moves to a cathode to which the positive voltage is applied and a hole moves to an anode to which the negative voltage is applied, thereby generating a current.

The second electrode 140 is disposed to face a column spacer 290, which is disposed on a lower side of the display panel 200. In this case, the second electrode 140 is spaced apart from the column spacer 290, and if an external touch occurs, the column spacer 290 contacts the second electrode 140.

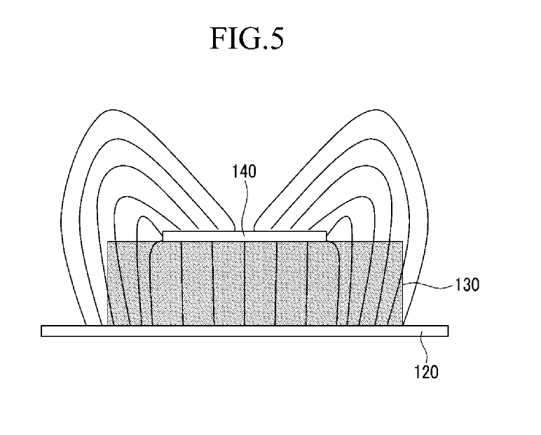

As will be described in more detail with respect to FIGS. 5 to 8, below, the column spacer 290 is formed of a conductive material, and if an external touch occurs on the surface of the display panel 200, the column spacer 290 contacts the second electrode 140, such that an electric field affecting the capacitance formed between the first electrode 120 and the second electrode 140 is increased.

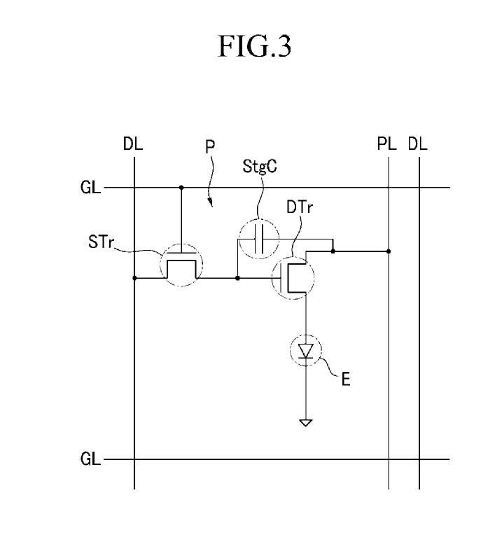

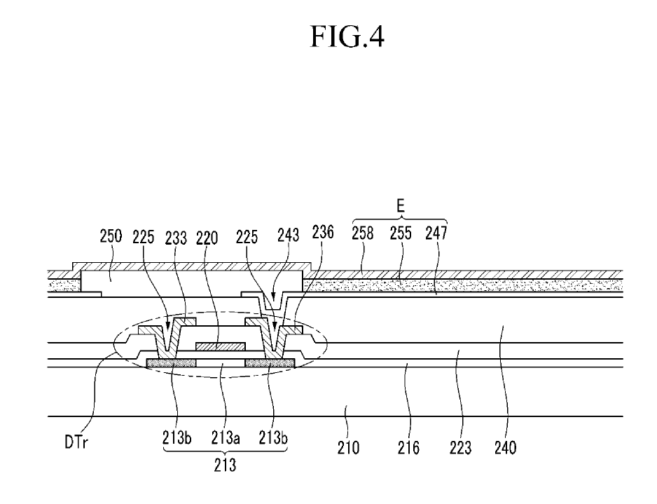

Hereinafter, with reference to FIG. 1, FIG. 3, and FIG. 4, the display panel 200 will be described in detail.

FIG. 3 is a circuit diagram illustrating a pixel of the organic light emitting diode display according to the exemplary embodiment of FIG. 1.

With reference to FIG. 3, a pixel of the organic light emitting diode display according to the exemplary embodiment includes a switching thin film transistor STr, a driving thin film transistor DTr, a storage capacitor StgC, and an organic electric field light emitting diode (LED) E.

A gate line GL is formed substantially in a horizontal direction, a data line DL is formed substantially in a vertical direction to cross the gate line GL, and a power line PL for applying a power voltage is formed in the vertical direction and is spaced apart from the data line DL.

The switching thin film transistor STr has a control terminal, an input terminal, and an output terminal, the control terminal is connected to the gate line GL, the input terminal is connected to the data line DL, and the output terminal is connected to the driving thin film transistor DTr.

The driving thin film transistor DTr also has a control terminal, an input terminal and an output terminal, the control terminal is connected to the switching thin film transistor STr, the input terminal is connected to the power line PL, and the output terminal is connected to the organic electroluminescent light emitting diode (LED) E.

The power line PL transmits the power voltage to the organic electroluminescent light emitting diode (LED) E, and a storage capacitor StgC is formed between the control terminal and the input terminal of the driving thin film transistor DTr.

Therefore, if signal is applied through the gate line GL, the switching thin film transistor STr is turned on, and the signal of the data line DL is transmitted to the control terminal of the driving thin film transistor DTr, such that the driving thin film transistor DTr is turned on, thereby outputting light through the organic electroluminescent light emitting diode (LED) E. The storage capacitor StgC, when the switching thin film transistor STr is turned off, functions to constantly maintain the gate voltage applied to the driving thin film transistor DTr, such that even though the switching thin film transistor STr is turned off, the level of the current flowing in the organic electroluminescent light emitting diode (LED) E may be constantly maintained until a subsequent frame.

FIG. 4 is an enlarged view illustrating portion A of a display panel of the organic light emitting diode display according to the exemplary embodiment of FIG. 1.

With reference to FIG. 1 and FIG. 4, the display panel 200 includes a second substrate 210 having an upper surface and a lower surface. The view shown in FIG. 4 is rotated 180° with respect to FIG. 1. In FIG. 1, a plurality of thin film transistor portions TP are formed on the surface of the second substrate 210 nearest the touch panel 100 (which is the lower surface of the second substrate 210 in FIG. 1), and a λ/4 polarizer P is disposed on the opposite surface of the second substrate 210 (which is the upper surface of the second substrate 210 in FIG. 1).

The λ/4 polarizer P may increase efficiency of light emitted from the organic emission layer 255 formed on the display panel 200. The polarizer P may be omitted.

The second substrate 210 may be formed of, for example, a transparent glass material or a transparent plastic material.

A semiconductor layer 213 is disposed on the surface of the second substrate 210. Semiconductor layer 213 includes a first region 213a that is formed of a pure polysilicon and forms a channel at the center thereof, and a second region 213b in which a high concentration of impurity is doped at both interfaces of the first region 213a.

A gate insulating layer 216 is formed on an entire surface thereof while covering the semiconductor layer 213, and a gate electrode 220 is formed on the gate insulating layer 216 to correspond to the first region 213a of the semiconductor layer 213. Further, on the gate insulating layer 216, a gate line (not shown) is disposed that is connected to a gate electrode (not shown), is one terminal of a switching thin film transistor (not shown), and extends in one direction.

An interlayer insulating layer 223 is formed on the entire surface of the gate electrode 220 and the gate line (not shown). Contact holes 225 for exposing the second regions 213b are formed through the interlayer insulating layer 223 and the gate insulating layer 216.

A data line (not shown) crossing the gate line (not shown) and a power line (not shown), which is spaced apart from the data line are formed on the upper portion of the interlayer insulating layer 223. In addition, a source electrode 233 and a drain electrode 236 formed on the interlayer insulating layer 223 and make contact with each of the second regions 213b exposed through the contact holes 225. The source electrode 233 and drain electrode 236, the semiconductor layer 213 including the second region 213b contacted with the electrodes 233 and 236, and the gate insulating layer 216 and gate electrode 220 formed on the upper portion of the semiconductor layer 213 form the driving thin film transistor DTr and can also form the switching thin film transistor (not shown in FIG. 4). In this case, the switching thin film transistor (not shown) is electrically connected to the driving thin film transistor DTr, the gate line (not shown), and the data line (not shown).

Meanwhile, the data line (not shown) is connected to a source electrode (not shown) of the switching thin film transistor (not shown).

In this case, the driving thin film transistor DTr and the switching thin film transistor (not shown) form a p type or n type thin film transistor according to the impurity doped to the second region 213b. The p type thin film transistor is formed by doping an element of Group 3, for example, boron (B) to the second region 213b, and a hole is used as a carrier.

Accordingly, the pixel electrode 247 connected to the drain electrode 236 of the driving thin film transistor DTr acts as an anode or a cathode according to the type of the driving thin film transistor DTr. In the present exemplary embodiment, the pixel electrode 247 connected to the driving thin film transistor DTr acts as a cathode.

On the entire surface of the driving thin film transistor DTr and the switching thin film transistor (not shown), a first passivation layer 240 is formed. A contact hole 243 for exposing the drain electrode 236 of the driving thin film transistor DTr is formed in the first passivation layer 240.

In addition, the pixel electrode 247 is formed on the first passivation layer 240 in which the contact hole 243 is formed, and contacts the drain electrode 236 of the driving thin film transistor(DTr) through the contact hole 243.

A buffer pattern 250 may be formed that overlaps with the circumference of the pixel electrode 247 and covering the driving thin film transistor(DTr).

An organic emission layer 255 is disposed on the pixel electrode 247 adjacent to the buffer pattern 250, and a common electrode 258 is disposed on the entire surface of the display area on the organic emission layer 255 and the buffer pattern 250. In this case, the pixel electrode 247 and the common electrode 258, and the organic emission layer 255 formed therebetween form an organic electroluminescent light emitting diode (LED) E.

Even though not illustrated in the drawing, a first emission compensation layer (not shown) and a second emission compensation layer (not shown) of a multi-layered structure may be further formed between the pixel electrode 247 and the organic emission layer 255, and the organic emission layer 255 and the common electrode 258, in order to improve light emission efficiency of the organic emission layer 255. The multi-layered first emission compensation layer (not shown) may be sequentially laminated on the pixel electrode 247 and may include an electron transporting layer and an electron injection layer. The second emission compensation layer (not shown) may be sequentially laminated from the central organic emission layer 255 and include a hole injection layer and a hole transporting layer.

Meanwhile, the common electrode 258 formed on the organic emission layer 255 is formed to act as an anode.

A second passivation layer 260 (FIG. 1), which is formed of, for example, an inorganic insulating material or an organic insulating material, is disposed on the common electrode 258 and formed on the entire surface of the display area. The second passivation layer 260 is formed in order to improve light efficiency of the organic emission layer 255, protect the common electrode 258, and prevent moisture from permeating the organic emission layer 255.

A packing film 270 for protecting the display panel 200 may be formed on the second passivation layer 260. The column spacer 290 is disposed on the packing film 270.

Although not illustrated in the drawing, edge portions of the first substrate 110 and the second substrate 210 may be sealed by a sealing material. The second electrode 140 formed on the first substrate 110 and the column spacer 290 formed on the second substrate 210 may be disposed to be spaced apart from each other at a regular interval by the sealing material.

Because the touch sensor in the exemplary embodiments includes both photosensing and capacitance sensing capabilities for sensing a touch on the touch panel, and these two types of sensors share the first electrode 120 and the second electrode 140 by a sensing line and a driving line, the display device may operate using only one of the photosensing and capacitance sensing capabilities, or both of the photosensing and capacitance sensing may be simultaneously operated. A switching method may be employed to switch between an operating mode using just one type of sensor and an operating mode that uses both types of sensors.

In the organic light emitting diode display according to the exemplary embodiment as described above, the touch panel 100 is disposed at the lower portion of the display panel 200, and the common electrode 258 forms an anode, and the pixel electrode 247 forms a cathode. Accordingly, light generated in the organic emission layer 255 of the display panel 200 does not pass through the touch panel 100 but is discharged in the first direction D1 to the outside of the display panel 200.

Thus, the first electrode 120 and the second electrode 140 constituting the photosensor 130 and the touch sensor are not limited to the non-emission portion region in order to prevent the transmittance deterioration, but because of this structural characteristic, may be formed over the entire region of the first substrate 110. Accordingly, in the exemplary embodiment, the areas of the photosensor 130, the first electrode 120, and the second electrode 140 may be enlarged. Sensing sensitivity may be improved by enlarging the area of the photosensor 130, and the response speed may be improved due to a decrease in resistance by enlarging the areas of the first electrode 120 and the second electrode 140.

In addition, in the case where multiple touches occur at the same time in adjacent nodes, force applied by touch may be sensed through the number of nodes in which a change in voltage value occurs.

In another exemplary embodiment, most constituents of the display device are the same as those of the exemplary embodiment described in FIG. 1 to FIG. 4, but an insulating layer may be formed on the touch panel 100 instead of the photosensor 130. In other words, unlike the exemplary embodiment as described above, the touch may be recognized solely by a change in capacitance according to the contact between the column spacer 290 and the second electrode 140 without performing the photosensing by the photosensor.

FIG. 5 is a schematic diagram illustrating the shape of an electric field in the case where there is no touch in the organic light emitting diode display according to the exemplary embodiment of FIG. 1.

With reference to FIG. 5, in the case where the user does not touch the surface of the second substrate 210, because a fringe field formed between the first electrode 120 and the second electrode 140 is constantly maintained, there is no change in capacitance, such that the touch sensor does not produce a signal.

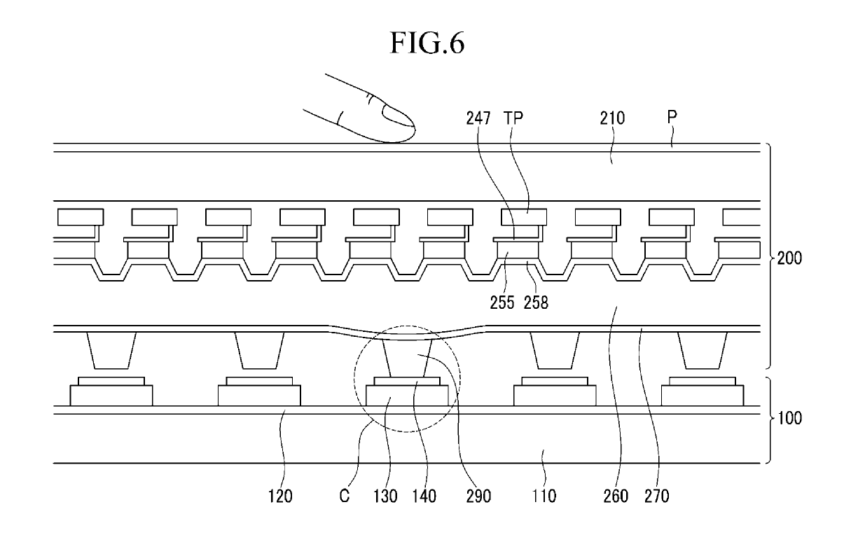

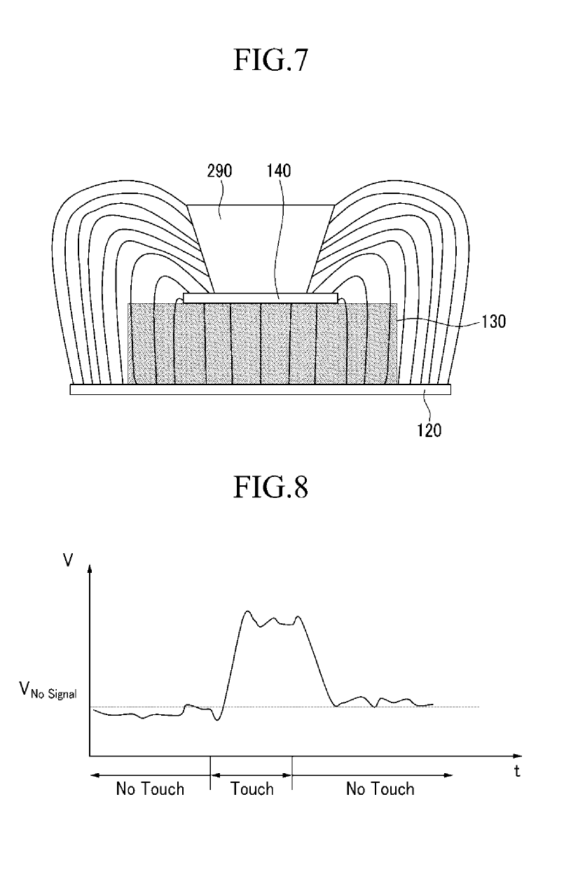

FIG. 6 is a cross-sectional view illustrating the case where a touch occurs on one surface of the organic light emitting diode display according to the exemplary embodiment of FIG. 1. FIG. 7 is a schematic diagram illustrating an electric field shape in the case where the touch occurs in the organic light emitting diode display according to the exemplary embodiment of FIG. 6. FIG. 8 is a graph illustrating a voltage change according to a time in the case where the touch occurs in the organic light emitting diode display according to the exemplary embodiment of FIG. 6.

With reference to FIG. 6 and FIG. 7, if a user touches the upper surface of the second substrate 210, pressure occurs in a direction of application of force, such that the column spacer 290 contacts the second electrode 140. Accordingly, the fringe field formed between the column spacer 290 and the second electrode 140 and the first electrode 120 is changed, such that the touch sensor produces a signal.

In detail, with reference to FIG. 8, when the column spacer 290 is contacted with the second electrode 140 by the pressure by the touch, an electric field amount is increased, thereby increasing voltage. A signal transmitted through the first electrode 120 acting as the sensing line may be shown as a difference in digital data values passing through an amplifier and an analog-to-digital converter.

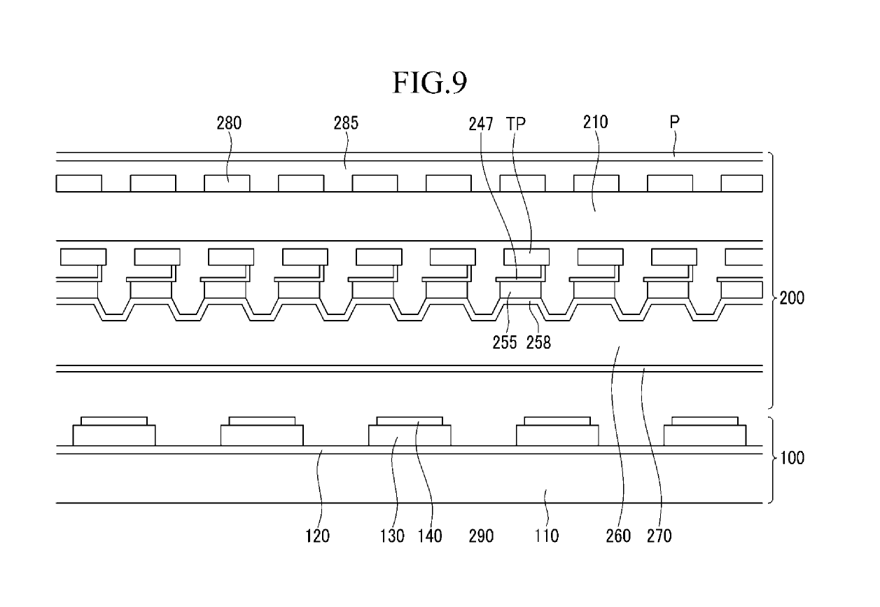

FIG. 9 is a cross-sectional view of an organic light emitting diode display according to another exemplary embodiment.

Since most constituents of the exemplary embodiment of FIG. 9 are the same as those of the exemplary embodiment as described in FIG. 1, just differences will be described.

With reference to FIG. 9, unlike the exemplary embodiment as described in FIG. 1, the column spacer 290 is not formed. However, a plurality of sensing lines 280 are disposed on the upper surface of the second substrate 210. A plurality of sensing line 280 may be arranged in a direction crossing the gate line (not shown) formed on the thin film transistor portion (TP).

The sensing line 280 and the gate line (not shown) included in the thin film transistor portion TP disposed at a lower portion of the sensing line 280 form a touch sensor. However, separately to this, the first electrode 120, the photosensor 130, and the second electrode 140 disposed on the touch panel 100 may recognize a touch on the display panel 200 by sensing a change in incident light.

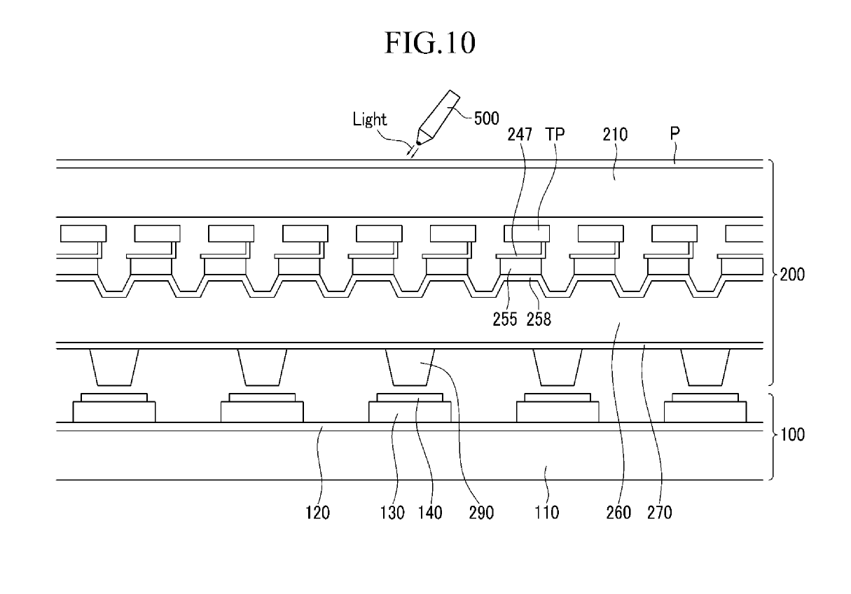

FIG. 10 is a cross-sectional view of an organic light emitting diode display according to yet another exemplary embodiment.

The constituents of the exemplary embodiment are the same as those of the exemplary embodiment of FIG. 1. However, while the exemplary embodiment of FIG. 1 senses a change in incident light by pressure or light blocking due to the touch of the user, in the present exemplary embodiment, the touch may be recognized by allowing the photosensor 130 to receive light having a predetermined wavelength band emitted from a device such as a stylus emitting light.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the disclosure, including the appended claims.

<Description of symbols>

| | |
|---|---|
| 100: Touch panel | 200: Display panel |
| 110: First substrate | 213: Semiconductor layer |
| 213a: First region | 213b: Second region |
| 216: Gate insulating layer | 220: Gate electrode |
| 223: Interlayer insulating layer | 225: Contact hole |
| 233: Source electrode | 236: Drain electrode |
| 240: First passivation layer | 243: Contact hole |
| 247: Pixel electrode | 255: Organic emission layer |
| 258: Common electrode | 260: Second passivation layer |
| 210: Second substrate | P: Polarizer |

What is claimed is:

1. An organic light emitting diode display, comprising:
a touch panel including a first substrate, a first electrode disposed on the first substrate, a photosensor disposed on the first electrode, and a second electrode disposed on the photosensor; and
a display panel including a second substrate, a thin film transistor disposed on the second substrate, a pixel electrode disposed on the thin film transistor, an emission layer disposed on the pixel electrode, a common electrode disposed on the emission layer, a passivation layer disposed on the common electrode, and a column spacer disposed on the passivation layer,
wherein the display panel is disposed on the touch panel, and
the column spacer and the second electrode face each other and are spaced apart from each other.

2. The organic light emitting diode display of claim 1, wherein:
the pixel electrode is a cathode, and the common electrode is an anode.

3. The organic light emitting diode display of claim 2, wherein:
light generated in the emission layer progresses in a direction away from the first substrate toward the second substrate.

4. The organic light emitting diode display of claim 3, wherein:
the second substrate includes an upper surface and a lower surface, and the thin film transistor is disposed on the lower surface of the second substrate, and
wherein the column spacer and the second electrode are contacted when the upper surface of the second substrate is touched, such that capacitance formed between the first electrode and the second electrode is changed.

5. The organic light emitting diode display of claim 4, wherein:
the first electrode and the second electrode are arranged in a matrix form, and the photosensor is disposed at a portion where the first electrode and the second electrode cross.

6. The organic light emitting diode display of claim 1, wherein:
the column spacer is formed of a conductive material.

7. The organic light emitting diode display of claim 6, wherein:
the column spacer is disposed in a position to correspond to a position of the photosensor.

8. The organic light emitting diode display of claim 1, wherein:
the pixel electrode and the common electrode are formed of a transparent conductive material.

9. The organic light emitting diode display of claim 1, wherein:
the sensing according to a change in the capacitance formed between the first electrode and the second electrode occurs simultaneously with a photosensing produced by the photosensor.

10. The organic light emitting diode display of claim 1, wherein:
the photosensor recognizes a touch in response to at least one of covering or receiving light having a predetermined wavelength band.

11. An organic light emitting diode display, comprising:
a touch panel including a first substrate, a first electrode disposed on the first substrate, a photosensor disposed on the first electrode, and a second electrode disposed on the photosensor;
a display panel including a second substrate including an upper surface and a lower surface, a plurality of gate lines disposed on the lower surface of the second substrate, a plurality of data lines crossing the plurality of gate lines, a first passivation layer covering the plurality of data lines, a pixel electrode disposed on the first passivation layer, an emission layer disposed on the pixel electrode, a common electrode disposed on the emission layer, and a second passivation layer disposed on the common electrode; and
a plurality of sensing lines disposed on the upper surface of the second substrate,
wherein the display panel is disposed on the touch panel.

12. The organic light emitting diode display of claim 11, wherein:
the plurality of sensing lines cross the gate line, capacitance is formed between the sensing line and the gate line, and if the upper surface of the second substrate is touched, the capacitance is changed.

13. The organic light emitting diode display of claim 12, wherein:
the pixel electrode is a cathode, and the common electrode is an anode.

14. The organic light emitting diode display of claim 13, wherein:
light generated in the emission layer progresses in a direction of away from the first substrate toward the second substrate.

15. The organic light emitting diode display of claim 14, wherein:
the first electrode and the second electrode are arranged in a matrix form, and the photosensor is disposed at a portion where the first electrode and the second electrode cross.

16. The organic light emitting diode display of claim 11, wherein:
the pixel electrode and the common electrode are formed of a transparent conductive material.

17. An organic light emitting diode display, comprising:
a touch panel including a first substrate, a first electrode disposed on the first substrate, an insulating layer disposed on the first electrode, and a second electrode disposed on the insulating layer; and
a display panel including a second substrate, a thin film transistor disposed on the second substrate, a pixel electrode disposed on the thin film transistor, an emission layer disposed on the pixel electrode, a common electrode disposed on the emission layer, a passivation layer disposed on the common electrode, and a column spacer disposed on the passivation layer,
wherein the display panel is disposed on the touch panel, and
the column spacer and the second electrode face each other and are spaced apart from each other.

18. The organic light emitting diode display of claim 17, wherein:
the pixel electrode is a cathode, and the common electrode is an anode.

19. The organic light emitting diode display of claim 18, wherein:
light generated in the emission layer progresses in a direction of away from the first substrate toward the second substrate.

20. The organic light emitting diode display of claim 19, wherein:
the first electrode and the second electrode are arranged in a matrix form, and
the insulating layer includes an insulation pattern disposed at a portion where the first electrode and the second electrode cross.
